(19) United States
(12) Patent Application Publication
(10) Pub. No.: US 2001/0048295 A1
(43) Pub. Date: Dec. 6, 2001

(54) Power supply device

(76) Inventor: Christoph Joch, Schwalbach (DE)

Correspondence Address: Martin A. Farber, Suite 473, 866 United Nations Plaza, New York, NY, 10017, US

(21) Appl. No.: 09/828,291

(22) Filed: Apr. 5, 2001

(30) Foreign Application Priority Data
Apr. 8, 2000 (DE) 100 17 590.2

(51) Int. Cl. G05F 1/40

(52) U.S. Cl. 323/282

(57) ABSTRACT

In a power supply device to which a DC voltage can be fed and which outputs a stabilized voltage for operating an electronic circuit in a motor vehicle, a step-up converter is arranged between an input for the operating voltage and an output of a voltage regulator, which step-up converter is activated when a battery voltage is below a predefined threshold voltage, and raises the battery voltage to at least the threshold value.

The invention relates to a power supply device to which a DC voltage can be fed and which outputs a stabilized voltage for operating an electronic circuit in a motor vehicle.

In electrical systems of vehicles the voltage is subjected to severe fluctuations in a range from 6 V to 27 V given a rated voltage of 14 V. Because many semiconductor switches are designed for a rated voltage of 5 V, a voltage regulator which stabilizes the fluctuating battery voltage to 5 V is usually provided for such semiconductor switches, in particular control devices. However, when the engine of the motor vehicle is started, the battery is loaded to such a high degree that voltage dips to below 5 V are possible. In such a case, the functioning of control devices is put at risk. In customary controllers used in the control devices, a reset is carried out when the voltage drops below 4.5 V±7%. Because a certain voltage drop of, for example, 0.4 V takes place in the voltage regulator, the lower limit for the DC voltage is approximately 5 V.

The object of the present invention is to permit control devices to be operated even with a DC voltage of less than 5 V to 6 V.

This object is achieved according to the invention in that a step-up converter is arranged between an input for the operating voltage and an input of a voltage regulator, which step-up converter is activated when a battery voltage is below a predefined threshold value, and raises the battery voltage to at least the threshold value. There is preferably provision here for the threshold value to be approximately 5 V to 6 V.

The measures according to the invention significantly improve the operating reliability of control devices in the lower voltage range. Thus, it is possible, for example, with the power supply device according to the invention to operate control devices even down to voltages of 3.5 V. In this range, the control device is not even operated in the marginal range of the specifications so that reliability is increased. In addition, only a low degree of expenditure on circuitry is necessary to implement the power supply device according to the invention.

An embodiment of the invention which is particularly easy to implement consists in forming the step-up converter from a series circuit which is composed of an inductor and a diode and is connected between the input and the input of the voltage regulator, the connecting point of the inductor to the diode being connected to ground potential via a semiconductor switch, and the input of the voltage regulator being connected to ground potential via a capacitor, and in controlling the semiconductor switch in a pulsating fashion when the voltage drops below the threshold value. There is preferably provision here for the semiconductor switch to be a field-effect transistor.

An advantageous possible way of activating or deactivating the step-up converter is possible according to one development of the invention by providing a differential amplifier for driving the semiconductor switch in a pulsating fashion, the output of which differential amplifier is connected to a control input of the semiconductor switch, to one input of which pulses can be fed from a clock transmitter and to the other input of which the input voltage of the voltage regulator is applied via a voltage divider.

The invention permits numerous embodiments. One of these is illustrated schematically in the drawing by means of a plurality of figures and is described below. In said drawing:

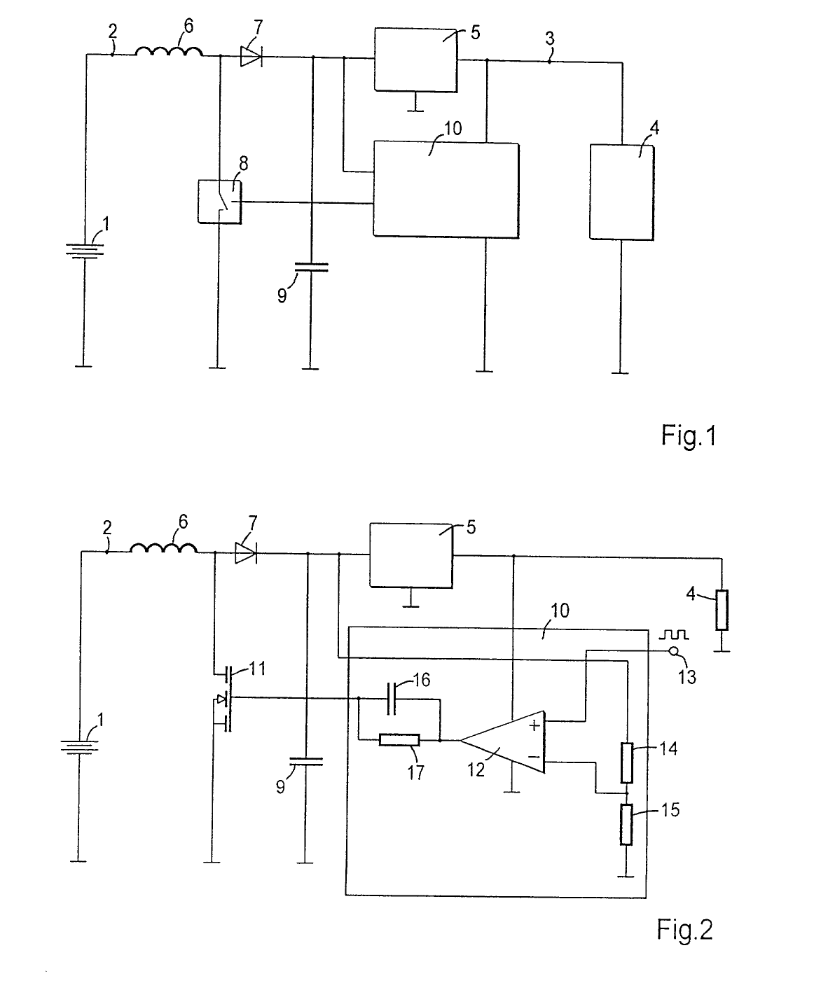

FIG. 1 shows a power supply device according to the invention, and

FIG. 2 shows a power supply device according to the invention in a more detailed representation.

Identical parts are provided with identical reference symbols in the figures.

A battery 1 whose voltage can fluctuate very severely and in doing so drop below 5 V is connected to the input 2 of the power supply device. The load 4 which contains electronic circuits which no longer operate reliably below a voltage of 5 V is connected to an output 3 of the power supply device. If the battery voltage drops to a value below 5.5 V, the voltage regulator 5 which is usually used is no longer capable of outputting a voltage of 5 V at its output.

For this reason, in the power supply device according to the invention a step-up converter, which is composed of an inductor 6, a diode 7, a semiconductor switch 8 and a capacitor 9, is provided upstream of the voltage regulator 5. A control circuit 10, to which the output voltage of the voltage regulator 5 is fed as operating voltage, receives the input voltage of the voltage regulator 5 and compares this with a threshold value voltage. When said input voltage drops below the threshold value voltage, it supplies control pulses to the semiconductor switch 8 so that the step-up converter is activated.

In the exemplary embodiment which is illustrated in more detail in FIG. 2, the load 4 is indicated merely by a resistor. The semiconductor switch 8 is formed by a field-effect transistor 11. The control circuit 10 is composed essentially of a differential amplifier 12, to whose noninverting input a clock signal is fed from a clock transmitter (not illustrated) via an input 13. The input voltage of the voltage regulator 5 is supplied via a voltage divider 14, 15. The output of the differential amplifier 12 is connected to the gate electrode of the field-effect transistor 11 via a parallel circuit composed of a capacitor 16 and a resistor 17 for performing adaptation to the gate electrode. As soon as the input voltage of the voltage regulator 5 is higher than 5.5 V, the differential amplifier 12 stops transmitting the clock signal to the field-effect transistor 11. This does not take place until the input voltage of the voltage regulator 5 drops below this value. If the battery voltage then continues to drop, the input voltage of the voltage regulator 5 maintains the value of approximately 5.5 V.

1. A power supply device to which a DC voltage can be fed and which outputs a stabilized voltage for operating an electronic circuit in a motor vehicle, wherein a step-up converter (6, 7, 8, 9) is arranged between an input (2) for the operating voltage and an input of a voltage regulator (5), which step-up converter (6, 7, 8, 9) is activated when a battery voltage is below a predefined threshold value, and raises the battery voltage to at least the threshold value.

2. The power supply device as claimed in claim 1, wherein the threshold value is approximately 5 V to 6 V.

3. The power supply device as claimed in one of claims 1 or 2, wherein the step-up converter is formed by a series circuit which is composed of an inductor (6) and a diode (7) and is connected between the input (2) and the input of the voltage regulator (5), the connecting point of the inductor (6) to the diode (7) being connected to ground potential via a semiconductor switch (8, 11), and the input of the voltage regulator (5) being connected to ground potential via a capacitor (9), and wherein the semiconductor switch (8, 11) is controlled in a pulsating fashion when the voltage drops below the threshold value.

4. The power supply device as claimed in claim 3, wherein the semiconductor switch is a field-effect transistor (11).

5. The power supply device as claimed in one of the preceding claims 3 or 4, characterized in that a differential amplifier (12) is provided for driving the semiconductor switch (11) in a pulsating fashion, the output of which differential amplifier (12) is connected to a control input of the semiconductor switch (11), to one input of which pulses can be fed from a clock transmitter and to the other input of which the input voltage of the voltage regulator (5) is applied via a voltage divider (14, 15).
